(19) United States
(12) Patent Application Publication
(10) Pub. No.: US 2026/0281933 A1
(43) Pub. Date: Sep. 17, 2026

(54) MAINTAINING A PLURALITY OF TIMING ADVANCES IN A SERVING CELL

(71) Applicant: Samsung Electronics Co., Ltd., Suwon-si (KR)

(72) Inventors: Anil Agiwal, Allen, TX (US); Shiyang Leng, Allen, TX (US); Kyeongin Jeong, Allen, TX (US)

(21) Appl. No.: 19/673,575

(22) Filed: May 11, 2026

Related U.S. Application Data
(63) Continuation of application No. 18/599,133, filed on Mar. 7, 2024.
(60) Provisional application No. 63/453,679, filed on Mar. 21, 2023.
(60) Provisional application No. 63/522,323, filed on Jun. 21, 2023.

(51) Int. Cl. H04W 56/00; H04W 74/0833

(52) U.S. Cl. CPC H04W 56/0045; H04W 74/0833

(57) ABSTRACT

A UE includes a transceiver. The transceiver is configured to transmit a UE capability information message including an indication that the UE supports multiple TAs per serving cell for multi-TRP operation, and receive a RRC reconfiguration message including a plurality of TAG IDs for a serving cell and a mapping between a plurality of TCI states and the plurality of TAG IDs for the serving cell. The UE further includes a processor operably coupled to the transceiver. The processor is configured to determine, based on the mapping, a TAG ID from the plurality of TAG IDs that corresponds with at least one TCI state from the plurality of TCI states. The mapping is signaled per BWP of the serving cell. The transceiver is further configured to transmit, to the serving cell, a RA preamble to obtain a TA for a TAG of the serving cell.

### CROSS-REFERENCE TO RELATED APPLICATION(S) AND CLAIM OF PRIORITY

This application is a continuation of U.S. patent application Ser. No. 18/599,133 filed on Mar. 7, 2024, which claims priority under 35 U.S.C. § 119 (e) to U.S. Provisional Patent Application No. 63/453,679 filed on Mar. 21, 2023, and U.S. Provisional Patent Application No. 63/522,323 filed on Jun. 21, 2023. The above-identified provisional patent applications are hereby incorporated by reference in their entirety.

### TECHNICAL FIELD

This disclosure relates generally to wireless networks. More specifically, this disclosure relates to apparatuses and methods for maintaining a plurality of timing advances in a serving cell.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for maintaining a plurality of timing advances in a serving cell.

In one embodiment, a user equipment (UE) is provided. The UE includes a transceiver. The transceiver is configured to transmit a UE capability information message including an indication that the UE supports multiple timing advancements (TAs) per serving cell for multi-transmit-receive point (TRP) operation, and receive a radio resource control (RRC) reconfiguration message including a plurality of timing advance group (TAG) identifications (IDs for a serving cell and a mapping between a plurality of TCI states and the plurality of timing TAG IDs for the serving cell. The UE further includes a processor operably coupled to the transceiver. The processor is configured to determine, based on the mapping, a TAG ID from the plurality of TAG IDs that corresponds with at least one TCI state from the plurality of TCI states. The mapping is signaled per bandwidth part (BWP) of the serving cell. The transceiver is further configured to transmit, to the serving cell, a random access (RA) preamble to obtain a TA for a TAG of the serving cell.

In another embodiment, a BS is provided. The BS includes a processor, and a transceiver operably coupled to the processor. The transceiver is configured to receive, from a UE, a UE capability information message including an indication that the UE supports multiple TAs per serving cell for multi-TRP operation. The transceiver is further configured to transmit a RRC reconfiguration message including a plurality if timing advance group (TAG) identifications (IDSO for a service cell and a mapping between a plurality of TCI states and the plurality of TAG IDs for the serving cell. The mapping is signaled per BWP of the serving cell. The transceiver is further configured to receive a RA preamble.

In yet another embodiment, a method of operating a UE is provided. The method includes transmitting a UE capability information message including an indication that the UE supports multiple TAs per serving cell for multi-transmit-receive point (TRP) operation, and receiving a RRC reconfiguration message including a plurality of timing advance group (TAG) identifications (IDs) for a serving cell and a mapping between a plurality of TCI states and the plurality of TAG IDs for the serving cell. The method further includes determining, based on the mapping, a TAG ID from the plurality of TAG IDs that corresponds with each TCI state from the plurality of TCI states. The mapping is signaled per BWP of the serving cell. The method further includes transmitting, to the serving cell, a RA preamble to obtain a TA for a TAG of the serving cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to this disclosure;

FIG. 3A illustrates an example UE according to embodiments of the present disclosure;

FIG. 3B illustrates an example gNB according to embodiments of the present disclosure;

FIG. 4 illustrates a method for maintaining a plurality of timing advances in a serving cell according to embodiments of the present disclosure;

FIG. 5 illustrates an example RRCReconfiguration message according to embodiments of the present disclosure;

FIG. 6 illustrates an example RRCReconfiguration message according to embodiments of the present disclosure;

FIG. 7 illustrates an example RRCReconfiguration message according to embodiments of the present disclosure;

FIG. 8 illustrates a method for PDCCH initiated random access according to embodiments of the present disclosure;

FIG. 9 illustrates a method for a random access operation for a serving cell configured with two TAGs according to embodiments of the present disclosure;

FIG. 10 illustrates a method for a random access operation for a serving cell configured with two TAGs according to embodiments of the present disclosure;

FIG. 11 illustrates a method for a random access operation for a serving cell configured with two TAGs according to embodiments of the present disclosure;

FIG. 12 illustrates a method for a random access operation for a serving cell configured with two TAGs according to embodiments of the present disclosure;

FIG. 13 illustrates a method for a random access operation for a serving cell configured with two TAGs according to embodiments of the present disclosure;

FIG. 14 illustrates a method for a random access operation for a serving cell configured with two TAGs according to embodiments of the present disclosure; and

FIG. 15 illustrates a method for maintaining a plurality of timing advances in a serving cell according to embodiments of the present disclosure.

### DETAILED DESCRIPTION

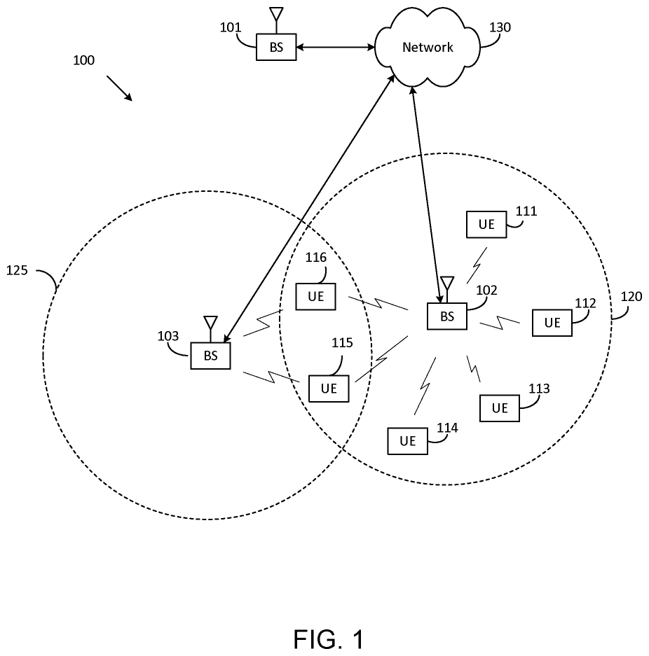

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for maintaining a plurality of timing advances in a serving cell in a wireless communication system. In certain embodiments, one or more of the gNBs 101-103 includes circuitry, programing, or a combination thereof, to support maintaining a plurality of timing advances in a serving cell in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

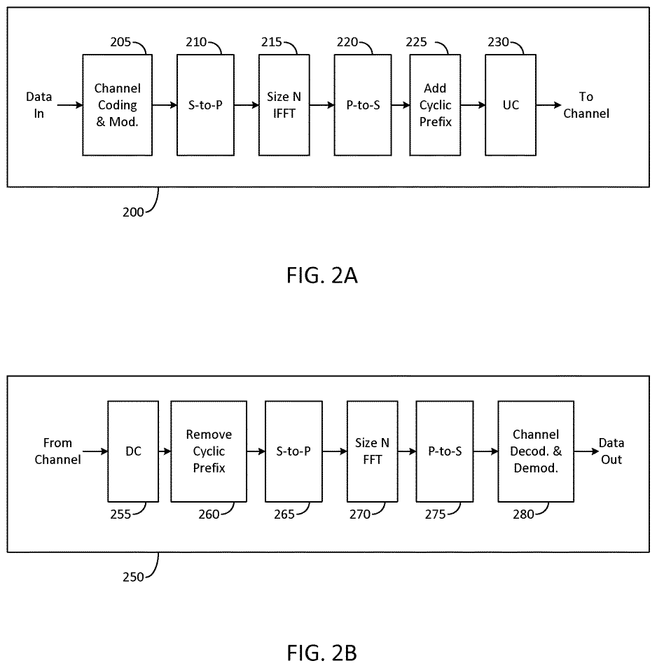

FIGS. 2A and 2B illustrate example wireless transmit and receive paths according to this disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the receive path 250 is configured to support the codebook design and structure for systems having 2D antenna arrays as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

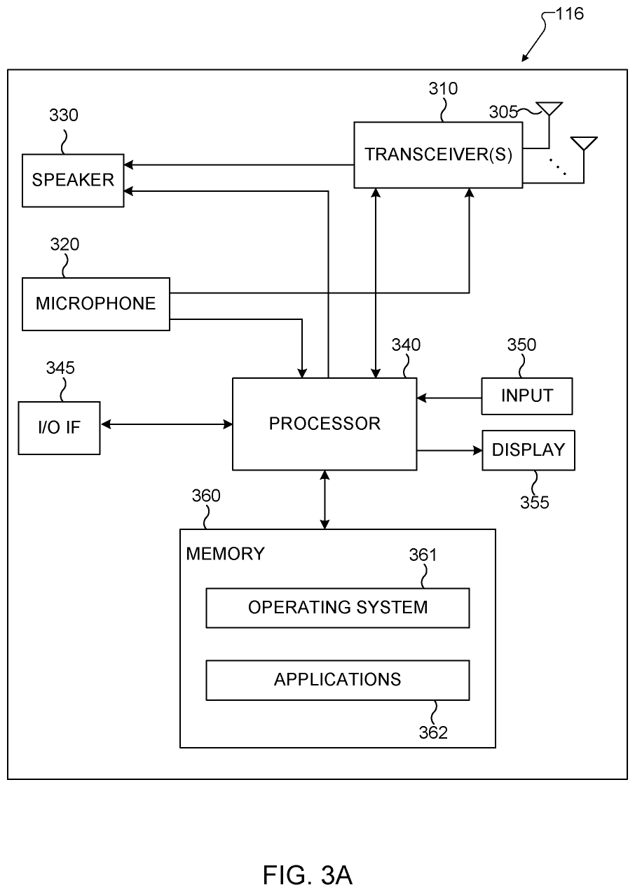

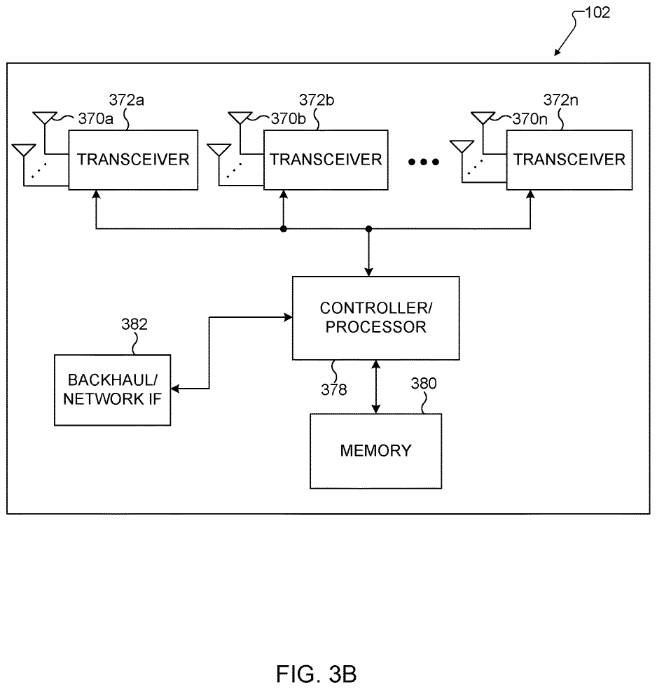

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for maintaining a plurality of timing advances in a serving cell as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support maintaining a plurality of timing advances in a serving cell as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The fifth-generation wireless communication system supports not only lower frequency bands but also higher frequency (mm Wave) bands, e.g., 10 GHz to 100 GHz bands, so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large-scale antenna techniques are being considered in the design of the fifth-generation wireless communication system. In addition, the fifth-generation wireless communication system is expected to address different use cases having quite different requirements in terms of data rate, latency, reliability, mobility etc. However, it is expected that the design of the air-interface of the fifth-generation wireless communication system would be flexible enough to serve UEs having quite different capabilities depending on the use case and market segment the UE caters to service the end customer. A few example use cases the fifth-generation wireless communication system is expected to address are enhanced Mobile Broadband (eMBB), massive Machine Type Communication (m-MTC), ultra-reliable low latency communication (URLL) etc. The eMBB requirements like tens of Gbps data rate, low latency, high mobility etc. address the market segment representing conventional wireless broadband subscribers needing internet connectivity everywhere, all the time and on the go. The m-MTC requirements like very high connection density, infrequent data transmission, very long battery life, low mobility, etc. address the market segment representing the Internet of Things (IoT)/Internet of Everything (IoE) envisioning connectivity of billions of devices. The URLL requirements like very low latency, very high reliability and variable mobility, etc. address the market segment representing industrial automation applications, vehicle-to-vehicle/vehicle-to-infrastructure communication foreseen as one of the enablers for autonomous cars, etc.

In the fifth-generation wireless communication system operating in higher frequency (mmWave) bands, UEs and gNBs communicate with each other using beamforming. Beamforming techniques are used to mitigate the propagation path losses and to increase the propagation distance for communication at higher frequency bands. Beamforming enhances the transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can make a plurality of transmit beam patterns of different directions. Each of these transmit beam patterns can also be referred to as a transmit (TX) beam. Wireless communication systems operating at high frequency uses a plurality of narrow TX beams to transmit signals in the cell as each narrow TX beam provides coverage to a part of the cell. The narrower the TX beam, the higher the antenna gain and hence the larger the propagation distance of a signal transmitted using beamforming. A receiver can also make a plurality of receive (RX) beam patterns of different directions. Each of these receive patterns can also be referred to as a receive (RX) beam.

The fifth generation wireless communication system supports a standalone mode of operation as well as dual connectivity (DC). In DC a multiple Rx/Tx UE may be configured to utilize resources provided by two different nodes (or NBs) connected via a non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in RRC_CONNECTED state not configured with CA/DC there is only one serving cell comprising the primary cell. For a UE in RRC_CONNECTED state configured with CA/DC the term ‘serving cells’ is used to denote the set of cells comprising of the Special Cell(s) and all secondary cells. In NR the term Master Cell Group (MCG) refers to a group of serving cells associated with the Master Node, comprising of the PCell and optionally one or more SCells. In NR the term Secondary Cell Group (SCG) refers to a group of serving cells associated with the Secondary Node, comprising of the PSCell and optionally one or more SCells. In NR PCell (primary cell) refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e., Special Cell) refers to the PCell of the MCG or the PSCell of the SCG, otherwise the term Special Cell refers to the PCell.

In the fifth generation wireless communication system, a node B (gNB) or base station in cell broadcast Synchronization Signal and PBCH block (SSB) comprises primary and secondary synchronization signals (PSS, SSS) and system information. System information includes common parameters needed to communicate in cell. In the fifth generation wireless communication system (also referred as next generation radio or NR), System Information (SI) is divided into the MIB and a number of SIBs where the MIB is always transmitted on the BCH with a periodicity of 80 ms and repetitions made within 80 ms and it includes parameters that are needed to acquire SIB1 from the cell. The SIB1 is transmitted on the DL-SCH with a periodicity of 160 ms and variable transmission repetition. The default transmission repetition periodicity of SIB1 is 20 ms but the actual transmission repetition periodicity depends on network implementation. For SSB and CORESET multiplexing pattern 1, the SIB1 repetition transmission period is 20 ms. For SSB and CORESET multiplexing patterns 2/3, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand, and, in that case, the configuration needed by the UE to perform the SI request. SIB1 is a cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as SI area, which comprises one or several cells and is identified by systemInformationAreaID; The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message; For a UE in RRC_CONNECTED state, the network can provide system information through dedicated signaling using the RRCReconfiguration message, e.g., if the UE has an active BWP with no common search space configured to monitor system information, paging, or upon request from the UE. In RRC_CONNECTED state, the UE acquires the required SIB(s) only from the PCell. For PSCell and SCells, the network provides the required SI by dedicated signaling, i.e., within an RRCReconfiguration message. Nevertheless, the UE shall acquire MIB of the PSCell to get SFN timing of the SCG (which may be different from MCG). Upon change of relevant SI for a SCell, the network releases and adds the concerned SCell. For a PSCell, the required SI can only be changed with Reconfiguration with Sync.

In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by a non-synchronized UE in RRC CONNECTED state. Several types of random-access procedures are supported such as contention based random access and contention free random access, and each of these can be one of 2 step or 4 step random access.

In the fifth generation wireless communication system, the Physical Downlink Control Channel (PDCCH) is used to schedule DL transmissions on PDSCH and UL transmissions on PUSCH, where the Downlink Control Information (DCI) on PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH. In addition to scheduling, PDCCH can be used to for activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for physical uplink control channel (PUCCH) and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In the fifth-generation wireless communication system, a list of search space configurations is signaled by the gNB for each configured BWP of serving cell wherein each search configuration is uniquely identified by a search space identifier. The search space identifier is unique amongst the BWPs of a serving cell. An Identifier of search space configuration to be used for a specific purpose such as paging reception, SI reception, and random access response reception is explicitly signaled by the gNB for each configured BWP. In NR search space configuration comprises of the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:
(y*(number of slots in a radio frame)+x-Monitoring-offset-PDCCH-slot) mod (Monitoring-periodicity-PDCCH-slot)=0;

The starting symbol of a PDCCH monitoring occasion in each slot having a PDCCH monitoring occasion is given by Monitoring-symbols-PDCCH-within-slot. The length (in symbols) of a PDCCH monitoring occasion is given in the corset associated with the search space. Search space configuration includes the identifier of coreset configuration associated with it. A list of coreset configurations are signaled by the gNB for each configured BWP of the serving cell, wherein each coreset configuration is uniquely identified by a coreset identifier. The Coreset identifier is unique amongst the BWPs of a serving cell. Note that each radio frame is of 10 ms duration. The radio frame is identified by a radio frame number or system frame number. Each radio frame comprises several slots wherein the number of slots in a radio frame and duration of slots depends on sub carrier spacing. The number of slots in a radio frame and duration of slots in a radio frame for each supported SCS is pre-defined in NR. Each coreset configuration is associated with a list of transmission configuration indicator (TCI) states. One DL RS ID (SSB or CSI RS) is configured per TCI state. The list of TCI states corresponding to a coreset configuration is signaled by the gNB via RRC signaling. One of the TCI states in a TCI state list is activated and indicated to the UE by the gNB. TCI state indicates the DL TX beam (DL TX beam is QCLed with SSB/CSI RS of TCI state) used by the GNB for transmission of PDCCH in the PDCCH monitoring occasions of a search space.

In the fifth-generation wireless communication system bandwidth adaptation (BA) is supported. With BA, the receive and transmit bandwidth of a UE need not be as large as the bandwidth of the cell and can be adjusted, the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor PDCCH on the one active BWP i.e., it does not have to monitor PDCCH on the entire DL frequency of the serving cell. In RRC connected state, the UE is configured with one or more DL and UL BWPs, for each configured Serving Cell (i.e., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the medium access control (MAC) entity itself upon initiation of Random-Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the existing system, a UE can be configured with one or more serving cells. Each serving cell is associated with one Timing Advance Group (TAG) wherein the UE maintains one Timing advance (or TA) value per TAG which is used for adjusting UL timing for the serving cell(s) associated with that TAG. Recently multiple TRP (Transmit Receive Point) communication is being enabled in the 5G system wherein a serving cell can have multiple TRPs, and the UE can communicate with each of TRPs of the serving cell to enhance throughput and reliability. DCI can be transmitted independently from each of these TRPs, and UL can be transmitted to each of these TRPs independently using the corresponding UL timing. To enable this functionality, the UE maintains multiple TAs per serving cell unlike the existing system wherein only one TA is maintained per serving cell.

In one example, the UE is in an RRC_IDLE/RRC_INACTIVE state and camped to a Cell (e.g., “Cell A”). The UE performs a random access (RA) procedure in this cell and obtains timing advance TA (e.g., “TA 1”) during the connection setup/resume. The UE starts the TimingAlignmentTimer. While the UE is in the RRC_CONNECTED state, an RRC configuration message is received from the gNB which indicates support of multiple TAs in a serving cell (e.g., by mapping TCI states to TAGs) for Cell A. Later based on random access procedure another TA (e.g., “TA2”) is obtained. In order to support multiple TAs per serving cell, several issues need to be addressed such as whether the UE initiates another random-access procedure for obtaining the second TA and if so, when does the UE trigger such a random-access procedure and which RA resources are used. Also, the network should determine which TAG of serving cell the random access procedure initiated by UE for a serving cell is for. The network may initiate a random access procedure for an additional TA of serving cell. In this case the UE should know whether this RA is for first or second TAG of serving Cell A. During the random access procedure, UE receives TA. TA may be received in RAR, fallbackRAR, absolute timing command MAC CE. Absolute timing command MAC CE is different from timing command MAC CE. Absolute timing command MAC CE includes absolute or complete TA whereas the timing command MAC CE includes difference between old TA (last informed to UE by gNB) and new TA. Mechanism to associate received TA to one of the TAG of serving cell is needed. Also, UE should determine whether there is a single TAT or separate TAT for each of the two TAGs of serving Cell. If there is separate TTA, which TAT of serving Cell is started when TA is received during the RA procedure. The UE should determine appropriate behavior if one or both of the timing advance timers (TATs) (a TAT is associated with a TAG) associated with the serving cell expires. Therefore, enhanced methods of signaling and maintaining multiple TAs in a serving cell are described in the present disclosure.

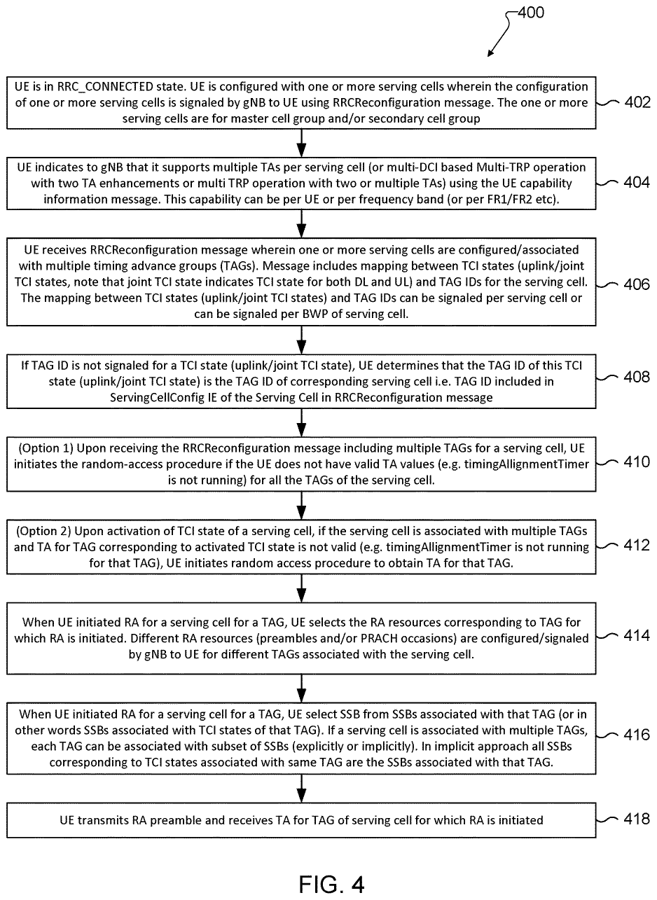

FIG. 4 illustrates a method 400 for maintaining a plurality of timing advances in a serving cell according to embodiments of the present disclosure. An embodiment of the method illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments for maintaining a plurality of timing advances in a serving cell could be used without departing from the scope of this disclosure.

As illustrated in FIG. 4, the method 400 begins at step 402. At step 402, a UE such as UE 116 of FIG. 1 is in an RRC_CONNECTED state. The UE is configured with one or more serving cells wherein the configuration of one or more serving cells is signaled by a gNB, such as gNB 103 of FIG. 1, to the UE using a signaling message (e.g. RRC message such as RRCReconfiguration message). Each of one or more configured serving cells belongs to either a master cell group or a secondary cell group.

A serving cell can be associated with one or more PCIs (Physical Cell Identities). If the serving cell is associated with multiple PCIs, the TA can be different for different PCIs, and one or more PCIs associated with the serving cell can also have the same TA. For example, if the serving cell has 4 PCIs, PCI 1 to 4, PCI 1 and PCI 2 can have the same TA whereas PCI 3 and PCI 4 can have a different TA depending on coverage. In another example, if the serving cell has 3 PCIs, PCI 1 to 3, all of them can have a different TA. If the serving cell is associated with one or more PCIs, the TA can be different between TCI states e.g., TCI states of one TRP can have a TA different from TCI states of another TRP.

At step 404, while the UE is in the RRC_CONNECTED state, the UE indicates to the gNB that it supports multiple Timing Advances (TAs) per serving cell (or the UE supports multi-DCI based Multi-TRP operation with two TA enhancements or multi TRP operation with two or more TAs) using the UE capability information message. This capability can be per UE (which means that UE supports or does not support multiple TAs irrespective of any frequency band) or per frequency band (or per FR1 (frequency range 1 i.e. 400 MHz to 7.125 GHZ)/FR2 (Frequency range 2 i.e. 24.25 GHz to 52.6 GHz) etc.), wherein the UE may support multiple TAs for some frequency bands/frequency range or all of them or none of them.

At step 406, if the UE supports multiple TAs per serving cell, the UE receives an RRCReconfiguration message from the gNB, wherein one or more serving cells are configured/associated with multiple timing advance groups (TAGs). The RRCReconfiguration message sent by the gNB to the UE includes mapping between TCI states (uplink/joint TCI states, note that a joint TCI state indicates a TCI state for both DL and UL) and TAG IDs for the serving cell. The mapping between TCI states (uplink/joint TCI states) and TAG IDs can be signaled per serving cell or can be signaled per BWP of the serving cell.

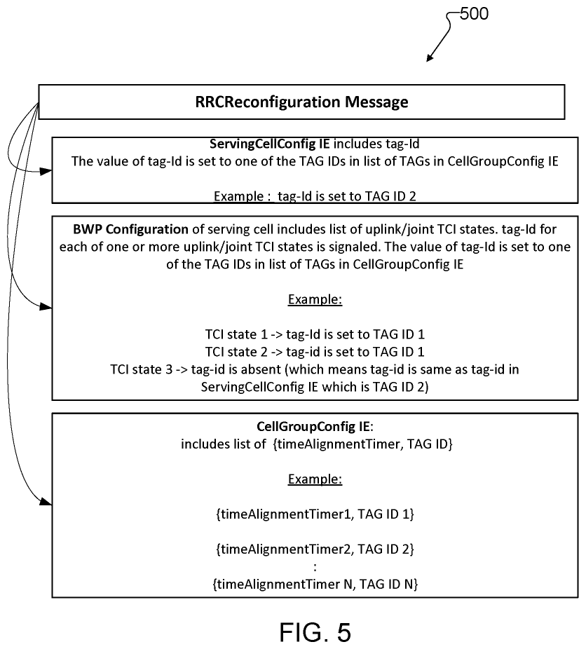

In one embodiment, at step 408, the UE associates multiple TAs to TCI states of a serving cell according to the signaling illustrated in FIG. 5.

FIG. 5 illustrates an example RRCReconfiguration message 500 according to embodiments of the present disclosure. The embodiment of a RRCReconfiguration message in FIG. 5 is for illustration only. Other embodiments of an RRCReconfiguration message 500 could be used without departing from the scope of this disclosure.

In the example of FIG. 5, RRCReconfiguration message includes ServingCellConfig IE. RRCReconfiguration message includes CellGroupConfig IE. CellGroupConfig IE includes list of TAGs. ServingCellConfig IE includes field tag-id. The field tag-id is set to one of the TAG IDs in list of TAGs in CellGroupConfig IE. BWP Configuration of serving cell includes list of uplink/joint TCI states. tag-Id field indicating TAG ID for each of one or more uplink/joint TCI states is optionally signaled. The value of tag-Id field in TCI state is set to one of the TAG IDs in list of TAGs in CellGroupConfig IE. If a TAG ID is not signaled (i.e. tag-Id field is absent) for a TCI state (uplink/joint TCI state), the UE considers that the TAG ID of this TCI state (uplink/joint TCI state) is the TAG ID of the corresponding serving cell i.e., the TAG ID included in a ServingCellConfig information element (IE) of the Serving Cell in the RRCReconfiguration message (or alternately it can be a default TAG ID, wherein a default TAG ID is pre-defined or signaled by the gNB in the RRCReconfiguration message). If the TAG ID is signaled for a TCI state (uplink/joint TCI state), the UE considers that the TAG ID of this TCI state (uplink/joint TCI state) is the signaled TAG ID. The TAG ID signaled for the TCI state or for the serving cell in the ServingCellConfig IE is the identity of one of the TAGs included in a TAG-Config (tag-ToAddModList) received in the RRC message for the cell group of the serving cell. The TAG-Config tag-ToAddModList includes a list of {timeAlignmentTimer, TAG ID}. A TAG ID for a TCI state of a serving cell can be the same as a TAG ID for a TCI state of another serving cell or can be the same as a TAG for a TCI state of another serving cell. For example, a PCell can be associated with two TAGs, TAG1 and TAG2. An SCell in the same cell group can be associated with TAG 2.

Although FIG. 5 illustrates one example RRCReconfiguration message 500, various changes may be made to FIG. 5. For example, the number of TAG IDs may vary, the value of setting of the TAG IDs may vary, etc. according to particular needs.

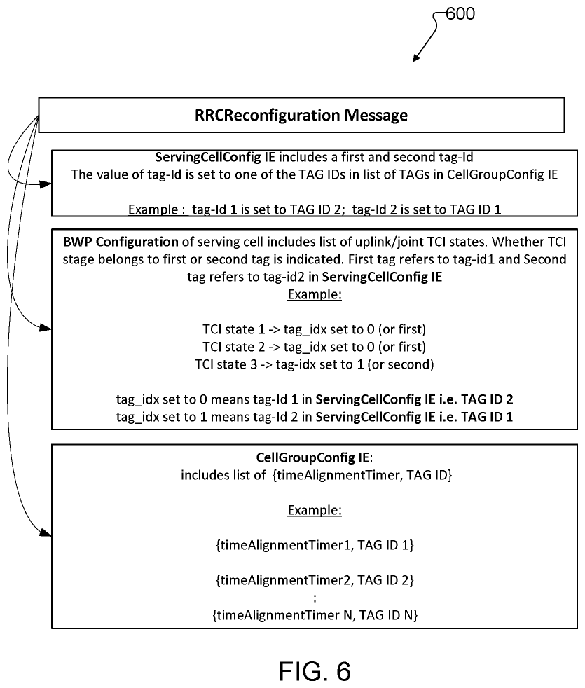

In one embodiment, at step 408, the UE associates multiple TAs to TCI states of a serving cell according to the signaling illustrated in FIG. 6.

FIG. 6 illustrates an example RRCReconfiguration message 600 according to embodiments of the present disclosure. The embodiment of a RRCReconfiguration message in FIG. 6 is for illustration only. Other embodiments of an RRCReconfiguration message 600 could be used without departing from the scope of this disclosure.

In the example of FIG. 6, the CellGroupConfig IE in RRCReconfiguration message includes list of {timeAlignmentTimer, TAG ID}. The ServingCellConfig IE in the RRCReconfiguration message includes a first and second tag-Id. The value of the tag-Id is set to one of the TAG IDs in the list of TAGs in the CellGroupConfig IE of the serving cell in the RRCReconfiguration message. BWP Configuration of serving cell includes a list of uplink/joint TCI states. Whether the TCI stage belongs to the first or second tag is indicated by the field tag-idx, wherein tag-idx is signalled per TCI state. The first tag refers to tag-id 1 and the second tag refers to tag-id2 in the ServingCellConfig IE. A tag-idx set to 0 (first) or 1 (second) indicates whether the TCI state belongs to first or second tag respectively.

Although FIG. 6 illustrates one example RRCReconfiguration message 600, various changes may be made to FIG. 6. For example, the number of TAG IDs may vary, the value of setting of the TAG IDs may vary, etc. according to particular needs.

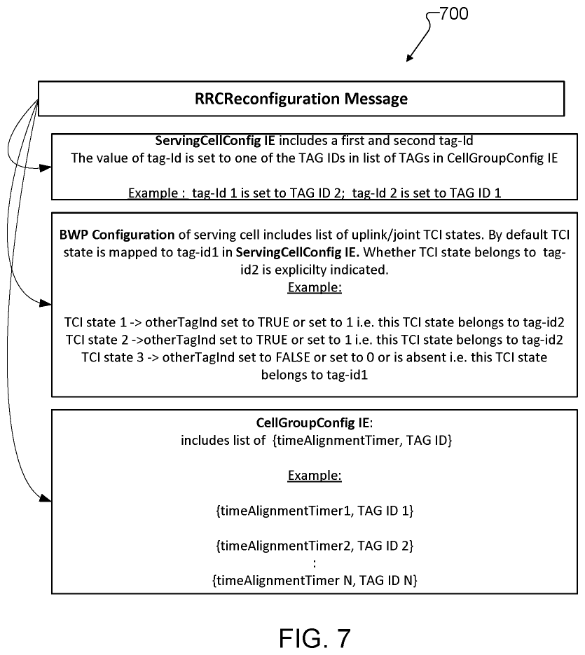

In one embodiment, at step 408, the UE associates multiple TAs to TCI states of a serving cell according to the signaling illustrated in FIG. 7.

FIG. 7 illustrates an example RRCReconfiguration message 700 according to embodiments of the present disclosure. The embodiment of a RRCReconfiguration message in FIG. 7 is for illustration only. Other embodiments of an RRCReconfiguration message 700 could be used without departing from the scope of this disclosure.

In the example of FIG. 7, the CellGroupConfig IE in RRCReconfiguration message includes a list of {timeAlignmentTimer, TAG ID}. The ServingCellConfig IE in the RRCReconfiguration message includes a first and second tag-Id. The value of the tag-Id is set to one of the TAG IDs in list of TAGs in the CellGroupConfig IE of the serving cell in the RRCReconfiguration message. BWP Configuration of the serving cell includes a list of uplink/joint TCI states. By default, a TCI state is mapped to tag-id1 in the ServingCellConfig IE. Whether the TCI state belongs to tag-id 2 is explicitly indicated (e.g., a field OtherTagInd or SecondTagInd per TCI state can be set to 1 or TRUE or present to indicate whether the corresponding TCI state belongs to second tag).

Although FIG. 7 illustrates one example RRCReconfiguration message 700, various changes may be made to FIG. 7. For example, the number of TAG IDs may vary, the value of setting of the TAG IDs may vary, etc. according to particular needs.

In one embodiment, at step 410, upon receiving the RRCReconfiguration message including multiple TAGs for a serving cell (e.g., at least two TAG IDs are associated with TCI states of the serving cell, note that the TCI states of the serving cell can be for the same PCI and/or different PCIs of the serving cell), the UE initiates a random-access procedure if the UE does not have valid TA values (e.g., a timingAlignmentTimer is not running) for all the TAGs of the serving cell. For example, if the serving cell is associated with TAG 1 and TAG 2, and the UE has valid TA only for TAG 1 and not for TAG 2, the UE initiates random access procedure to obtain the TA for TAG 2. If the timingAlignmentTimer is running for TAG1 and not running for TAG 2, the UE initiates a random access procedure to obtain the TA for TAG 2.

In one embodiment, at step 410, upon receiving the RRCReconfiguration message including multiple TAGs for a serving cell (e.g., at least two TAG IDs are associated with TCI states of the serving cell, note that TCI states of the serving cell can be for the same PCI and/or different PCIs of serving cell) for the active BWP, the UE initiates the random-access procedure if the UE does not have valid TA values (e.g., timingAlignmentTimer is not running) for all the TAGs of the serving cell. For example, if the active BWP of the serving cell is associated with TAG 1 and TAG 2, and the UE has a valid TA only for TAG 1 and not for TAG 2, the UE initiates a random access procedure to obtain the TA for TAG 2. If the timingAlignmentTimer is running for TAG1 and not running for TAG 2, the UE initiates a random access procedure to obtain TA for TAG 2.

In one embodiment, at step 412, upon activation of a TCI state of a serving cell, if the serving cell is associated with multiple TAGs (e.g., at least two TAG IDs are associated with TCI states of the serving cell, note that the TCI states of the serving cell can be for the same PCI and/or different PCIs of serving cell) and the TA for the TAG corresponding to the activated TCI state is not valid (e.g., timingAlignmentTimer is not running for that TAG), the UE initiates a random access procedure to obtain the TA for that TAG. For example, if the serving cell is associated with TAG 1 and TAG 2, TCI state 1 is associated with TAG 1 and the TCI state is associated with TAG2, the UE has a valid TA only for TAG 1 and not for TAG 2, and the UE initiates a random access procedure to obtain the TA for TAG 2 when TCI state 2 is activated.

In one embodiment, at step 412, upon activation of the TCI state of a serving cell, if the active BWP of the serving cell is associated with multiple TAGs (e.g., at least two TAG IDs are associated with TCI states of an active BWP of serving cell, note that TCI states of the serving cell can be for the same PCI and/or different PCIs of serving cell) and the TA for the TAG corresponding to the activated TCI state is not valid (e.g., a timingAlignmentTimer is not running for that TAG), the UE initiates a random access procedure to obtain the TA for that TAG. For example, if the serving cell is associated with TAG 1 and TAG 2, TCI state 1 is associated with TAG 1 and the TCI state is associated with TAG2, the UE has a valid TA only for TAG 1 and not for TAG 2, and the UE initiates a random access procedure to obtain the TA for TAG 2 when TCI state 2 is activated.

In one embodiment, at step 414, different RA resources (preambles and/or PRACH occasions) can be configured in a serving cell for different TAGs associated with the serving cell. These different RA resources can be configured per BWP of serving cell. The UE selects the RA resources corresponding to the TAG for which the RA is initiated. For example, if the serving cell is associated with TAG 1 and TAG 2, RA resources per BWP can be configured separately for TAG 1 and TAG 2. If the RA is initiated for TAG 2, RA resources corresponding to that TAG are used by the UE for transmitting a PRACH preamble.

In another embodiment, at step 416, if a serving cell is associated with multiple TAGs, each TAG can be associated with a subset of SSBs (explicitly signaled by a gNB in an RRC message per BWP of the serving cell/common for all BWPs of serving cell or implicitly). In the implicit approach all SSBs corresponding to TCI states associated with same TAG are the SSBs associated with that TAG. When the UE initiates RA for a serving cell for a TAG, the UE selects an SSB from SSBs associated with that TAG (or in other words SSBs associated with TCI states of that TAG). The UE then selects an RA preamble and RACH occasion corresponding to that SSB and transmits the RA preamble in the selected RO.

In one embodiment, upon receiving the RRCReconfiguration message including the multiple TAGs for a serving cell (e.g., at least two TAG IDs are associated with TCI states of the serving cell, note that TCI states of the serving cell can be for the same PCI and/or different PCIs of serving cell), the UE initiates the random-access procedure if the UE receives a command (e.g. PDCCH order) from the network indicating UE to initiate RACH (or random access procedure) for a serving cell. In this embodiment:
The serving cell for which RACH is to be initiated is indicated by PDCCH order.
The serving cell is associated with up to two TAGs. In case the serving cell is associated with two TAGs, a one bit indication is included in the PDCCH order which indicates whether the PDCCH order is for a TA of the first or the second TAG of the serving cell. The first TAG may correspond to the TAG ID included in Serving Cell Config IE and the second TAG may correspond to the TAG ID indicated for TCI state(s) of the serving cell. The first TAG may correspond to a TAG ID with a lower value amongst the two TAG IDs of the serving cell.
A one bit indication can be included in a random access response message or absolute timing advance command medium access control (MAC) control element (CE) which are sent by the network during the random access procedure. In case the serving cell is associated with two TAGs, the one bit indicates whether the TA is for the first or second TAG of the serving cell. The first TAG may correspond to the TAG ID included in the Serving Cell Config IE and the second TAG may correspond to the TAG ID indicated for TCI state(s) of the serving cell. The first TAG may correspond to the TAG ID with a lower value amongst the two TAG IDs of the serving cell.
In one embodiment, the UE checks the SSB index included in the PDCCH order. The UE identifies if there is a TCI state of the serving cell (for which PDCCH order is sent by gNB) in the active BWP associated with the SSB index, and the UE considers that the random access to be initiated is for the TAG associated with that TCI state. The TA received during the RA procedure (i.e. in a random access response message or absolute timing advance command medium access control (MAC) control element (CE) is applied for that TAG.

In one embodiment, at step 418, upon initiation of the RA procedure to obtain the TA for a TAG of the serving cell, the UE may select 4 step RA. The UE uses contention-based RA resources for RA preamble transmission. Upon transmitting the RA preamble, the UE monitors the PDCCH of the SpCell for Random Access Response(s) identified by the RA-RNTI while the ra-ResponseWindow is running. If a valid downlink assignment has been received on the PDCCH for the RA-RNTI and the received transport block (TB) is successfully decoded and if the Random Access Response contains a MAC sub-protocol data unit (subPDU) with Random Access Preamble identifier corresponding to the transmitted preamble, the Random Access Response reception is successful. The UE applies the received Timing Advance Command for the indicated TAG in a MAC subPDU with a Random Access Preamble identifier and starts the corresponding timing alignment timer. The UE processes the received UL grant for UL transmission (Msg3) towards the TRP of the serving cell associated with a TAG for which RA was initiated. The UE transmits a C-RNTI MAC CE in Msg3, and the UE starts a contention resolution timer upon Msg3 transmission and waits for a contention resolution message from gNB. If a PDCCH addressed to C-RNTI is received from a SpCell, contention resolution is successful, and the random-access procedure is completed. In case the contention resolution timer expires, The UE stops the timing alignment timer which was started upon reception of a RAR. In case the same timing alignment timer is used for multiple TAs of the serving cell, upon expiry of a contention resolution timer, the UE restores the timing alignment timer to the value which was there at the time of restarting the timer when the RAR was received.

In one embodiment, at step 418, upon initiation of the RA procedure to obtain the TA for a TAG of the serving cell, the UE may select 4 step RA. The UE uses contention free RA resources for RA preamble transmission. Upon transmitting the RA preamble, the UE monitors the PDCCH of the SpCell for Random Access Response(s) identified by the RA-RNTI while the ra-ResponseWindow is running. If a valid downlink assignment has been received on the PDCCH for the RA-RNTI and the received TB is successfully decoded and if the Random Access Response contains a MAC subPDU with Random Access Preamble identifier corresponding to the transmitted preamble, the Random Access Response reception is successful. The UE applies the received Timing Advance Command for the indicated TAG in the MAC subPDU with Random Access Preamble identifier. The RA is completed upon reception of a RAR, and the UE may ignore the received UL grant or UE process the received UL grant for UL transmission towards the TRP of serving cell associated with TAG for which RA was initiated.

In one embodiment, at step 418, upon initiation of the RA procedure to obtain the TA for a TAG of the serving cell, the UE may select 4 step RA. The UE uses contention free RA resources for RA preamble transmission. Upon transmitting the RA preamble, the UE monitors the PDCCH of the SpCell for Random Access Response(s) identified by the C-RNTI while the ra-ResponseWindow is running. If a valid downlink assignment has been received on the PDCCH for the C-RNTI and the received TB is successfully decoded and if the TB includes absolute timing advance command MAC CE wherein the MAC CE includes TA for TAG for which RA was initiated, the Random Access Response reception is successful. The UE applies the received Timing Advance Command for the indicated TAG and the RA is completed.

In one embodiment, at step 418, upon initiation of the RA procedure to obtain the TA for a TAG of the serving cell, the UE may select 2 step RA. Upon transmitting the RA preamble and MsgB MAC PDU, the UE monitors the PDCCH of the SpCell for Random Access Response(s) identified by the MsgB-RNTI while the msgB-Response Window is running. The UE also monitors the PDCCH of the SpCell for C-RNTI. If a valid downlink assignment has been received on the PDCCH for the C-RNTI and the received TB is successfully decoded and if the TB includes an absolute timing advance command MAC CE wherein the MAC CE includes a TA for the TAG for which RA was initiated, the Random Access Response reception is successful. The UE applies the received Timing Advance Command for the indicated TAG and the RA is completed. If a valid downlink assignment has been received on the PDCCH for the MsgB-RNTI and the received TB is successfully decoded and if the MsgB contains a success RAR MAC subPDU with a Random Access Preamble identifier corresponding to the transmitted preamble Random Access Response reception is successful. The UE applies the received Timing Advance Command for the indicated TAG in a successRAR MAC subPDU with a Random Access Preamble identifier. The RA is completed upon reception of the RAR, and the UE may ignore the received UL grant or UE process the received UL grant for UL transmission towards the TRP of serving cell associated with the TAG for which the RA was initiated.

Although FIG. 4 illustrates one example of a method 400 for maintaining a plurality of timing advances in a serving cell, various changes may be made to FIG. 4. For example, while shown as a series of steps, various steps in FIG. 4 could overlap, occur in parallel, occur in a different order, occur any number of times, be omitted, or replaced by other steps.

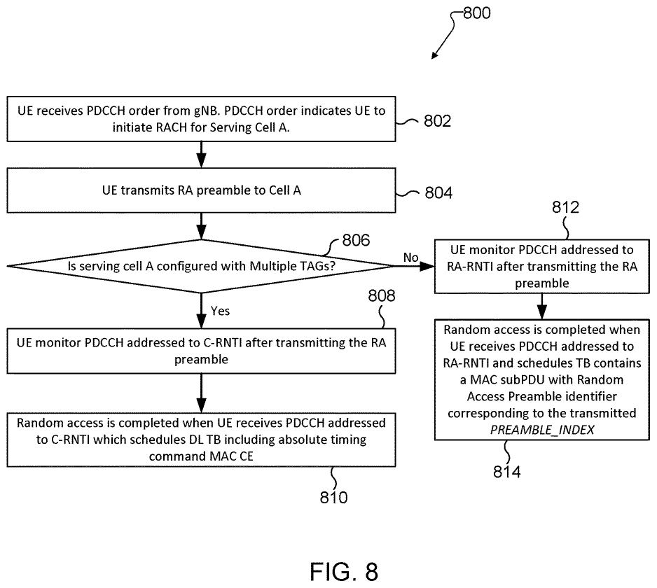

FIG. 8 illustrates a method 800 for PDCCH initiated random access according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments for PDCCH initiated random access could be used without departing from the scope of this disclosure.

As illustrated in FIG. 8, the method 800 begins at step 802. At step 802, a UE such as UE 116 of FIG. 1 receives a PDCCH order from a gNB such as such as gNB 103 of FIG. 1. The PDCCH order indicates for the UE to initiate RACH for a Serving Cell A. At step 804, the UE selects 4 step RA and transmits an RA preamble to Cell A. At step 806, the UE determines if Cell A is configured with multiple TAGs. If Cell A is configured with multiple TAGs the method proceeds to step 808. Otherwise, the method proceeds to step 812. At step 808, the UE monitors the PDCCH (of SpCell) addressed to C-RNTI after transmitting the RA preamble. At step 810, random access is completed when the UE receives PDCCH addressed to C-RNTI which schedules DL TB including absolute timing advance command MAC CE (with TA for TAG for which RA is initiated). At step 812, the UE monitors PDCCH (of SpCell) addressed to RA-RNTI after transmitting the RA preamble. At step 814, random access is completed when the UE receives PDCCH addressed to RA-RNTI, and schedules TB contains a MAC subPDU with a Random Access Preamble identifier corresponding to the transmitted PREAMBLE_INDEX.

Although FIG. 8 illustrates one example of a method 800 for PDCCH initiated random access, various changes may be made to FIG. 8. For example, while shown as a series of steps, various steps in FIG. 8 could overlap, occur in parallel, occur in a different order, occur any number of times, be omitted, or replaced by other steps.

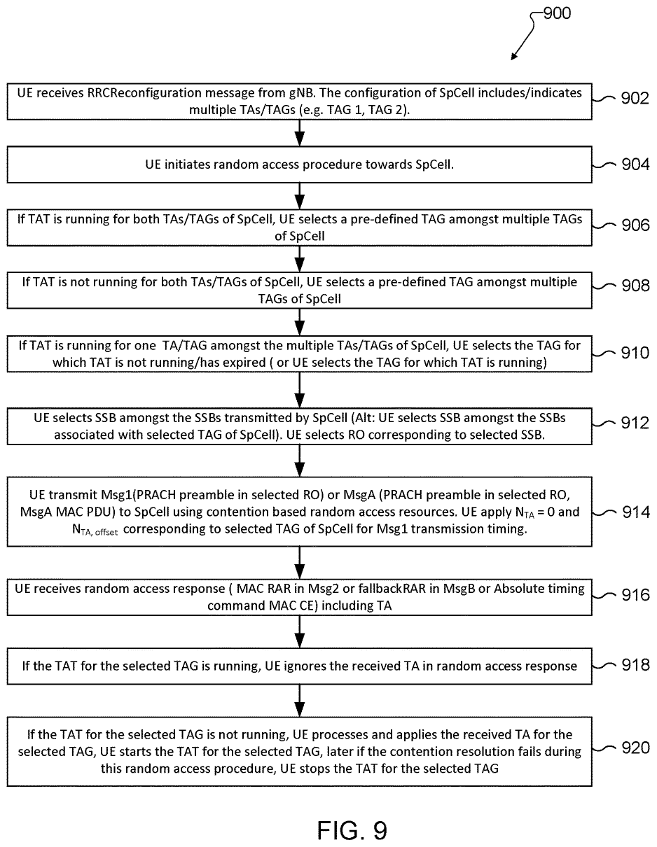

FIG. 9 illustrates a method 900 for a random access operation for a serving cell configured with two TAGs according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for a random access operation for a serving cell configured with two TAGs could be used without departing from the scope of this disclosure.

In the example of FIG. 9, a serving cell is configured with two TAGs (TAG1 and TAG2). As illustrated in FIG. 9, the method 900 begins at step 902. At step 902 a UE such as UE 116 of FIG. 1 receives an RRCReconfiguration message from a gNB such as such as gNB 103 of FIG. 1. The configuration of the serving cell (e.g., SpCell) includes/indicates multiple TAs/TAGs (e.g., TAG 1, TAG 2). At step 904, the UE initiates a random access procedure (e.g., if a scheduling request is triggered and the UE does not have PUCCH resources for transmitting the scheduling request, the UE initiates random access procedure. Similarly, for LBT failure recovery, beam failure recovery, etc., the UE may initiate random access procedure in RRC connected state).

At step 906, if a TAT is running for both TAs/TAGs of serving cell (e.g., SpCell), the UE selects a pre-defined TAG amongst multiple TAGs of the serving cell (e.g., SpCell). The pre-defined TAG can be TAG1 or TAG2. At step 908 if a TAT is not running for both TAs/TAGs of the serving cell (e.g., SpCell), the UE selects a pre-defined TAG amongst multiple TAGs of the serving cell (e.g., SpCell). The pre-defined TAG can be TAG1 or TAG2. At step 910, if a TAT is running for one TA/TAG amongst the multiple TAs/TAGs of the serving cell (e.g., SpCell), the UE selects the TAG for which a TAT is not running/has expired (or UE selects the TAG for which a TAT is running).

At step 912, the UE selects an SSB amongst the SSBs transmitted by the serving cell (e.g., SpCell) (Alternately, the UE selects an SSB amongst the SSBs associated with the selected TAG of the serving cell (e.g., SpCell)). The UE selects an RO corresponding to selected SSB. At step 914, the UE transmits a Msg1 (PRACH preamble in selected RO) or MsgA (PRACH preamble in selected RO, MsgA MAC PDU) to the serving cell (e.g., SpCell) using contention based random access resources. The UE applies an adjustment value N_{TA}=0 and N_{TA, offset} corresponding to the selected TAG of the serving cell (e.g., SpCell) for Msg1/PRACH preamble transmission timing. At step 916, the UE receives a random access response (MAC RAR in Msg2 or fallback RAR in MsgB or Absolute timing command MAC CE) including a TA.

At step 920, if the TAT for the selected TAG is running, UE ignores the received TA in random access response. If the TAT for the selected TAG is not running, the UE processes and applies the received TA for the selected TAG. The UE starts the TAT for the selected TAG. Later if the contention resolution fails during this random access procedure, the UE stops the TAT for the selected TAG.

Although FIG. 9 illustrates one example of a method 900 for a random access operation for a serving cell configured with two TAGs, various changes may be made to FIG. 9. For example, while shown as a series of steps, various steps in FIG. 9 could overlap, occur in parallel, occur in a different order, occur any number of times, be omitted, or replaced by other steps.

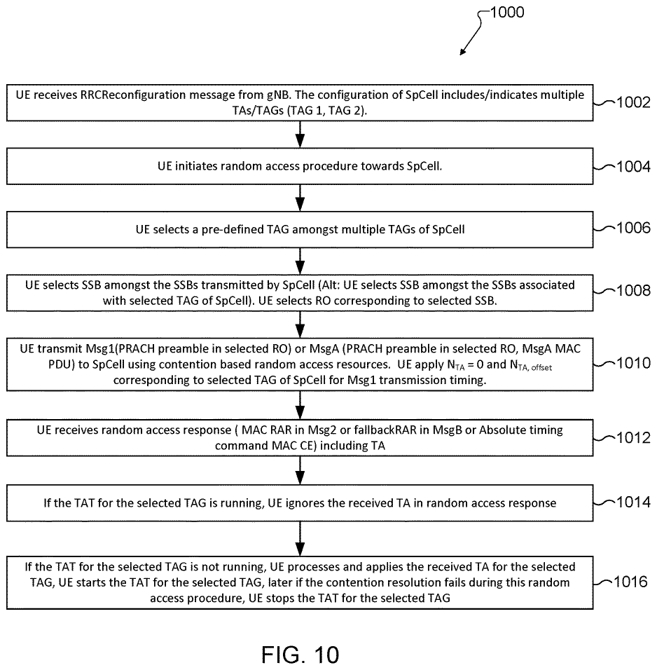

FIG. 10 illustrates a method 1000 for a random access operation for a serving cell configured with two TAGs according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments for a random access operation for a serving cell configured with two TAGs cell could be used without departing from the scope of this disclosure.

In the example of FIG. 10, a serving cell is configured with two TAGs (TAG1 and TAG2). As illustrated in FIG. 10, the method 1000 begins at step 1002. At step 1002, a UE such as UE 116 of FIG. 1 receives a RRCReconfiguration message from a gNB such as such as gNB 103 of FIG. 1. The configuration of the serving cell (e.g., SpCell) includes/indicates multiple TAs/TAGs (e.g., TAG 1, TAG 2). At step 1004, the UE initiates a random access procedure (e.g., if a scheduling request is triggered and the UE does not have PUCCH resources for transmitting the scheduling request, the UE initiates the random access procedure. Similarly, for LBT failure recovery, beam failure recovery, etc., the UE may initiate a random access procedure in a RRC connected state).

At step 1006, the UE selects a pre-defined TAG amongst multiple TAGs of the serving cell (e.g., SpCell). The pre-defined TAG can be TAG1 or TAG2. At step 1008, the UE selects an SSB amongst the SSBs transmitted by the serving cell (e.g., SpCell) (Alternately, the UE selects an SSB amongst the SSBs associated with the selected TAG of the serving cell (e.g., SpCell)). The UE selects a RO corresponding to selected SSB. At step 1010, the UE transmits a Msg1 (PRACH preamble in the selected RO) or MsgA (PRACH preamble in the selected RO, MsgA MAC PDU) to the serving cell (e.g., SpCell) using contention based random access resources. The UE applies N_{TA}=0 and N_{TA, offset} corresponding to the selected TAG of the serving cell (e.g., SpCell) for Msg1/PRACH preamble transmission timing.

At step 1012, the UE receives a random access response (MAC RAR in Msg2 (in case Msg1 is transmitted) or a fallbackRAR in a MsgB or an Absolute timing command MAC CE in case a MsgA is transmitted) including a TA. At step 1014, If the TAT for the selected TAG is running, the UE ignores the received TA in random access response. At step 1016, if the TAT for the selected TAG is not running, the UE processes and applies the received TA for the selected TAG, the UE starts the TAT for the selected TAG, and later if the contention resolution fails during this random access procedure, the UE stops the TAT for the selected TAG.

Although FIG. 10 illustrates one example of a method 1000 for a random access operation for a serving cell configured with two TAGs, various changes may be made to FIG. 10. For example, while shown as a series of steps, various steps in FIG. 10 could overlap, occur in parallel, occur in a different order, occur any number of times, be omitted, or replaced by other steps.

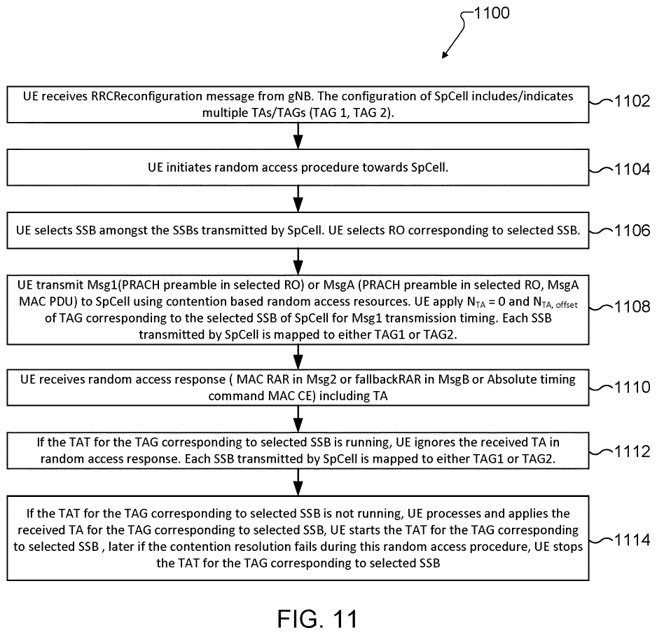

FIG. 11 illustrates a method 1100 for a random access operation for a serving cell configured with two TAGs according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments f for a random access operation for a serving cell configured with two TAGs could be used without departing from the scope of this disclosure.

In the example of FIG. 11, a serving cell is configured with two TAGs (TAG1 and TAG2). As illustrated in FIG. 11, the method 1100 begins at step 1102. At step 1102, a UE such as UE 116 of FIG. 1 receives a RRCReconfiguration message from a gNB such as such as gNB 103 of FIG. 1. The configuration of serving cell (e.g., SpCell) includes/indicates multiple TAs/TAGs (e.g., TAG 1, TAG 2). At step 1104, the UE initiates a random access procedure (e.g., if a scheduling request is triggered and the UE does not have PUCCH resources for transmitting the scheduling request, the UE initiates the random access procedure).

At step 1106, the UE selects a SSB amongst the SSBs transmitted by the serving cell (e.g., SpCell). The UE selects a RO corresponding to selected SSB. At step 1108, the UE transmits a Msg1 (PRACH preamble in the selected RO) or a MsgA (PRACH preamble in the selected RO, MsgA MAC PDU) to the serving cell (e.g., SpCell) using contention based random access resources. The UE applies N_{TA}=0 and N_{TA, offset} of the TAG corresponding to the selected SSB of the serving cell (e.g., SpCell) for Msg1/PRACH preamble transmission timing. Each SSB transmitted by the serving cell (e.g., SpCell) is mapped to either TAG1 or TAG2 and this mapping is signaled to the UE by the gNB (e.g., in the RRCReconfiguration message).

At step 1110, the UE receives a random access response (MAC RAR in Msg2 (in case Msg1 is transmitted) or a fallbackRAR in a MsgB or Absolute timing command MAC CE in case a MsgA is transmitted) including a TA. At step 1112, if the TAT for the TAG corresponding to the selected SSB is running, UE ignores the received TA in random access response. Each SSB transmitted by serving cell (e.g., SpCell) is mapped to either TAG1 or TAG2. At step 1114, if the TAT for the TAG corresponding to the selected SSB is not running, the UE processes and applies the received TA for the TAG corresponding to the selected SSB, the UE starts the TAT for the TAG corresponding to the selected SSB, and later if the contention resolution fails during this random access procedure, the UE stops the TAT for the TAG corresponding to the selected SSB.

Although FIG. 11 illustrates one example of a method 1100 for a random access operation for a serving cell configured with two TAGs, various changes may be made to FIG. 11. For example, while shown as a series of steps, various steps in FIG. 11 could overlap, occur in parallel, occur in a different order, occur any number of times, be omitted, or replaced by other steps.

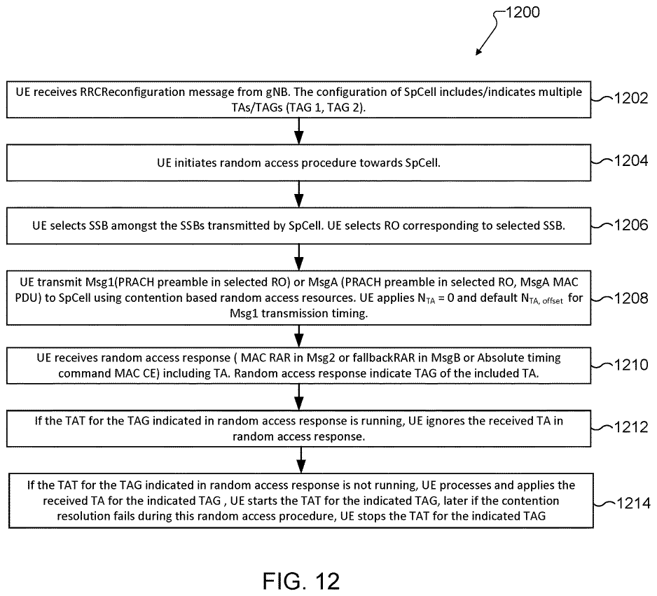

FIG. 12 illustrates a method 1200 for a random access operation for a serving cell configured with two TAGs according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments for a random access operation for a serving cell configured with two TAGs could be used without departing from the scope of this disclosure.

In the example of FIG. 12, a serving cell is configured with two TAGs (TAG1 and TAG2). As illustrated in FIG. 12, the method 1200 begins at step 1202. At step 1202 a UE such as UE 116 of FIG. 1 receives a RRCReconfiguration message from a gNB such as such as gNB 103 of FIG. 1. The configuration of the serving cell (e.g., SpCell) includes/indicates multiple TAs/TAGs (e.g., TAG 1, TAG 2). At step 1204, the UE initiates a random access procedure (e.g., if a scheduling request is triggered and the UE does not have PUCCH resources for transmitting the scheduling request, the UE initiates the random access procedure. Similarly, for LBT failure recovery, beam failure recovery, etc. as defined in TS 38.321, the UE may initiate a random access procedure in a RRC connected state).

At step 1206, the UE selects a SSB amongst the SSBs transmitted by the serving cell (e.g., SpCell). The UE selects a RO corresponding to selected SSB. At step 1208, the UE transmits a Msg1 (PRACH preamble in selected RO) or a MsgA (PRACH preamble in the selected RO, MsgA MAC PDU) to the serving cell (e.g., SpCell) using contention based random access resources. The UE applies N_{TA}=0 and default N_{TA, offset} for Msg1/PRACH preamble transmission timing. Alternately, instead of a default N_{TA, offset}, N_{TA, offset} for TAG1 or N_{TA, offset} for TAG2 is used. N_{TA, offset} for TAG1 and N_{TA, offset} for TAG2 is signaled by gNB (e.g., in the RRCReconfiguration message). In one embodiment, a maximum of N_{TA, offset} for TAG1 and N_{TA}, offset for TAG2 or a minimum of N_{TA, offset} for TAG1 and N_{TA, offset} for TAG2 can be used.

At step 1210, the UE receives a random access response (MAC RAR in Msg2 (in case Msg1 is transmitted) or a fallbackRAR in MsgB or Absolute timing command MAC CE in case MsgA is transmitted) including a TA. The random access response indicates the TAG of the included TA. For example, a one bit field in the random access response may indicate the first or second TAG of the serving cell. At step 1212, if the TAT for the TAG indicated in the random access response is running, the UE ignores the received TA in random access response. At step 1214, if the TAT for the TAG indicated in the random access response is not running, the UE processes and applies the received TA for the indicated TAG, the UE starts the TAT for the indicated TAG, and later if the contention resolution fails during this random access procedure, the UE stops the TAT for the indicated TAG.

Although FIG. 12 illustrates one example of a method 1200 for a random access operation for a serving cell configured with two TAGs, various changes may be made to FIG. 12. For example, while shown as a series of steps, various steps in FIG. 12 could overlap, occur in parallel, occur in a different order, occur any number of times, be omitted, or replaced by other steps.

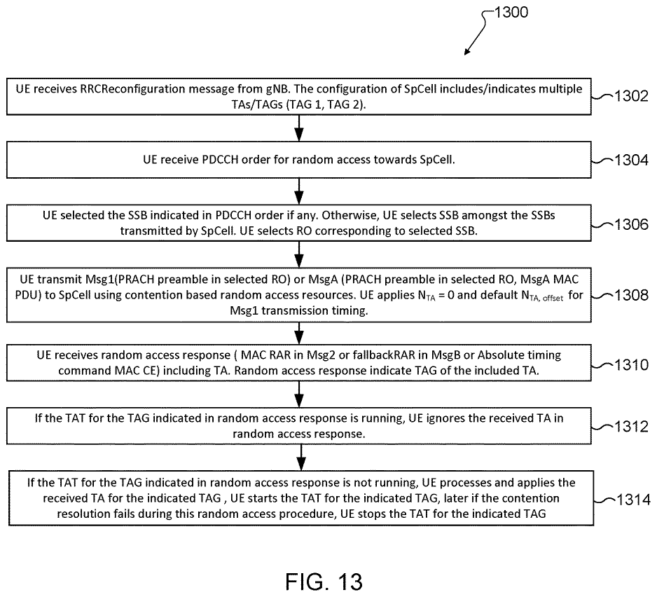

FIG. 13 illustrates a method 1300 for a random access operation for a serving cell configured with two TAGs according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments for a random access operation for a serving cell configured with two TAGs could be used without departing from the scope of this disclosure.

In the example of FIG. 13, a serving cell is configured with two TAGs (TAG1 and TAG2). As illustrated in FIG. 13, the method 1300 begins at step 1302. At step 1302 a UE such as UE 116 of FIG. 1 receives a RRCReconfiguration message from a gNB such as such as gNB 103 of FIG. 1. The configuration of the serving cell (e.g., SpCell) includes/indicates multiple TAs/TAGs (e.g., TAG 1, TAG 2). At step 1304, the UE receives a PDCCH order for initiating random access procedure for the serving cell (e.g., SpCell).

At step 1306, the UE selects the SSB indicated in the PDCCH order if any. Otherwise, the UE selects a SSB amongst the SSBs transmitted by the serving cell (e.g., SpCell). The UE selects an RO corresponding to selected SSB. At step 1308, the UE transmits a Msg1 (PRACH preamble in selected RO) or a MsgA (PRACH preamble in the selected RO, MsgA MAC PDU) to the serving cell (e.g., SpCell) using contention based random access resources. The UE applies N_{TA}=0 and default N_{TA, offset} for Msg1/PRACH preamble transmission timing. Alternately, instead of default N_{TA, offset}, N_{TA, offset} for TAG1 or N_{TA, offset} for TAG2 is used. N_{TA, offset} for TAG1 and N_{TA, offset} for TAG2 is signaled by the gNB (e.g., in a RRCReconfiguration message). In an embodiment a maximum of N_{TA, offset} for TAG1 and N_{TA, offset} for TAG2 or a minimum of N_{TA}, offset for TAG1 and N_{TA, offset} for TAG2 can be used.

At step 1310, the UE receives a random access response (MAC RAR in Msg2 (in case Msg1 is transmitted) or a fallbackRAR in MsgB or an Absolute timing command MAC CE in case MsgA is transmitted) including a TA. The random access response indicates the TAG of the included TA. For example, a one bit field in the random access response may indicate the first or second TAG of the serving cell. At step 1312, if the TAT for the TAG indicated in random access response is running, the UE ignores the received TA in random access response. At step 1314, if the TAT for the TAG indicated in random access response is not running, the UE processes and applies the received TA for the indicated TAG, the UE starts the TAT for the indicated TAG, and later if the contention resolution fails during this random access procedure, the UE stops the TAT for the indicated TAG.

Although FIG. 13 illustrates one example of a method 1300 for a random access operation for a serving cell configured with two TAGs, various changes may be made to FIG. 13. For example, while shown as a series of steps, various steps in FIG. 13 could overlap, occur in parallel, occur in a different order, occur any number of times, be omitted, or replaced by other steps.

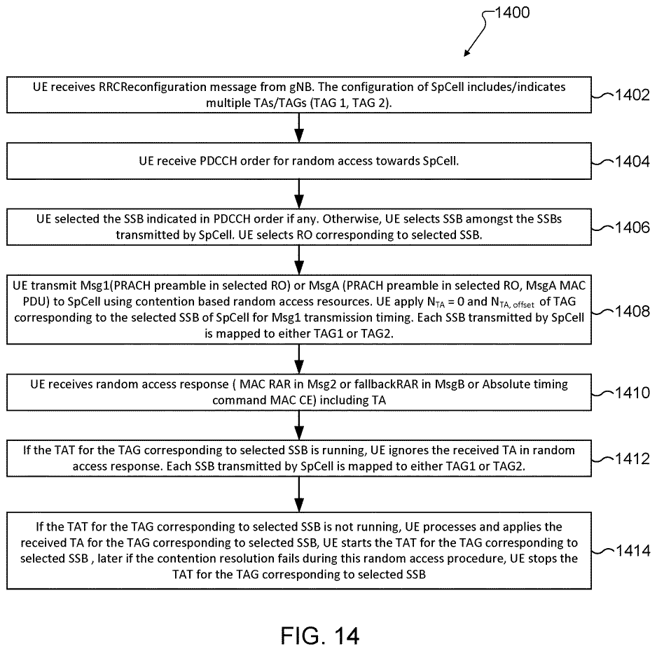

FIG. 14 illustrates a method 1400 for a random access operation for a serving cell configured with two TAGs according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments for a random access operation for a serving cell configured with two TAGs could be used without departing from the scope of this disclosure.

In the example of FIG. 14, a serving cell is configured with two TAGs (TAG1 and TAG2). As illustrated in FIG. 14, the method 1400 begins at step 1402. At step 1402 a UE such as UE 116 of FIG. 1 receives RRCReconfiguration message from a gNB such as such as gNB 103 of FIG. 1. The configuration of the serving cell (e.g., SpCell) includes/indicates multiple TAs/TAGs (e.g., TAG 1, TAG 2). At step 1404, the UE receives a PDCCH order for initiating a random access procedure for the serving cell (e.g., SpCell).

At step 1406, the UE selects the SSB indicated in the PDCCH order if any. Otherwise, the UE selects a SSB amongst the SSBs transmitted by the serving cell (e.g., SpCell). The UE selects a RO corresponding to selected SSB. At step 1408, the UE transmits a Msg1 (PRACH preamble in selected RO) or a MsgA (PRACH preamble in selected RO, MsgA MAC PDU) to the SpCell using contention based random access resources. The UE applies N_{TA}=0 and N_{TA, offset} of the TAG corresponding to the selected SSB of the SpCell for Msg1/PRACH preamble transmission timing. Each SSB transmitted by the SpCell is mapped to either TAG1 or TAG2 and this mapping is signaled to the UE by the gNB (e.g., in the RRCReconfiguration message).

At step 1410, the UE receives a random access response (MAC RAR in Msg2 (in case Msg1 is transmitted) or a fallbackRAR in MsgB or an Absolute timing command MAC CE in case MsgA is transmitted) including a TA. At step 1412, if the TAT for the TAG corresponding to selected SSB is running, the UE ignores the received TA in the random access response. Each SSB transmitted by the SpCell is mapped to either TAG1 or TAG2. At step 1414, if the TAT for the TAG corresponding to the selected SSB is not running, the UE processes and applies the received TA for the TAG corresponding to selected SSB, the UE starts the TAT for the TAG corresponding to the selected SSB, and later if the contention resolution fails during this random access procedure, the UE stops the TAT for the TAG corresponding to the selected SSB.

Although FIG. 14 illustrates one example of a method 1400 for a random access operation for a serving cell configured with two TAGs, various changes may be made to FIG. 14. For example, while shown as a series of steps, various steps in FIG. 14 could overlap, occur in parallel, occur in a different order, occur any number of times, be omitted, or replaced by other steps.

In one embodiment, an Uplink frame number i for transmission from the UE shall start

$${T}_{T A} = ( {N}_{T A} + {N}_{TA , offset} + {N}_{T A , a d j}^{c o m m o n} + {N}_{TA , adj}^{UE} ) {T}_{c}$$

frame at the UE where
N_{TA} and N_{TA,offset} are given by clause 4.2 of [5, TS 38.213], except for msgA transmission on PUSCH where N_{TA}=0 shall be used;

$${N}_{T A , a d j}^{c o m m o n}$$

given vy clause 4.2 of [5, TS 38.213] is derived from the higher-layer parameters TACommon, TACommonDrift, and TACommonDriftVariation if configured, otherwise

$${N}_{T A , a d j}^{c o m m o n} = 0 ;$$

$${N}_{TA , adj}^{UE}$$

given by clause 4.2 of [5, TS 38.213] is computed by the UE based on UE position and serving-satellite-ephemeris-related higher-layers parameters if configured, otherwise

$${N}_{T A , a d j}^{UE} = 0 .$$

In one embodiment, upon obtaining the TA for a TAG of the serving cell, the UE (re) starts the TimingAlignmentTimer corresponding to the TAG. The value of the timer in this case is obtained from TAG-Config (tag-ToAddModList) wherein the value is given by a timeAlignmentTimer field corresponding to the TAG ID of the TAG for which TA is obtained.

In an embodiment, when a timeAlignmentTimer expires, a MAC entity in the UE shall operate as follows:
if the timeAlignmentTimer is associated with the SpCell and there is no other timeAlignmentTimer associated with this SpCell is running (for example if SpCell is associated with two TAGs and timeAlignmentTimer associated with each of these TAGS is expired):
   flush all hybrid automatic repeat request (HARQ) buffers for all Serving Cells of the cell group of SpCell;
   notify RRC to release PUCCH for all Serving Cells c, if configured;
   notify RRC to release SRS for all Serving Cells of the cell group of SpCell, if configured;
   clear any configured downlink assignments and configured uplink grants;
   clear any PUSCH resource for semi-persistent channel state information (CSI) reporting;
   consider all running timeAlignmentTimers as expired;
   maintain N_{TA} of all TAGs where NTAis a timing adjustment value.
if the timeAlignmentTimer is associated with the SpCell and there is another timeAlignmentTimer associated with SpCell is running (e.g., for a different TAG of SpCell)
   Suspend UL transmissions corresponding to TCI state associated with TAG of expired timeAlignmentTimer
if the timeAlignmentTimer is associated with an STAG:
   if there is at least one activated SCell belonging to this STAG for which none of the timeAlignmentTimers associated with its TAG(s) are running:
      flush all HARQ buffers;
      notify RRC to release PUCCH, if configured;
      notify RRC to release SRS, if configured;
      clear any configured downlink assignments and configured uplink grants;
      clear any PUSCH resource for semi-persistent CSI reporting;
      maintain N_{TA} (defined in TS 38.211 [8]) of this TAG, where N_{TA} is a timing adjustment value.
   Else
      Suspend UL transmissions corresponding to TCI state associated with TAG of expired timeAlignmentTimer

In an embodiment, when an Absolute Timing Advance Command is received in response to a PDCCH order for a TAG of serving cell, the MAC entity in UE applies the Timing Advance Command for the TAG indicated in Absolute Timing Advance Command or PDCCH order.

In an embodiment, the TimingAlignmentTimer can be common for all TAGs of the serving cell and whenever a TA for any of the TAGs of the serving cell is received by UE from gNB, UE (re) starts the TimingAlignmentTimer. The value of the timer in this case is obtained from the TAG-Config (tag-ToAddModList) wherein the value is given by a time AlignmentTimer field corresponding to TAG ID signaled in ServingCellConfig IE of serving cell.

In an embodiment, when UE receives the TA for a TAG in a random access response message for a serving cell from the gNB, the MAC entity in UE performs the following operation:
1> if the Random Access Preamble was not selected by the MAC entity among the contention-based Random-Access Preamble:
   2> apply the Timing Advance Command for this TAG;
   2> if multiple TAGs are associated with the serving cell (i.e. serving cell for which random access response message is received)
      3> start the timeAlignmentTimer associated with this TAG (or start the time AlignmentTimer associated with the TAGs of serving cell for which random access response is received;
   2> else
      3> start or restart the timeAlignmentTimer associated with this TAG.
1> else if multiple TAGs are associated with the serving cell (i.e. serving cell for which random access response message is received)
   2> apply the Timing Advance Command for this TAG;
   2> start the timeAlignmentTimer associated with this TAG (or start the time AlignmentTimer associated with the TAGs of serving cell for which random access response is received;
   2> when the Contention Resolution is considered not successful during the RA procedure:
      3> set the N_{TA} value (e.g., adjustment value) to the value before applying the received Timing Advance Command
   2> else if the time AlignmentTimer associated with this TAG is not running:
      3> apply the Timing Advance Command for this TAG;
      3> start the timeAlignmentTimer associated with this TAG;
      3> when the Contention Resolution is considered not successful as described in clause 5.1.5; or
      3> when the Contention Resolution is considered successful for SI request as described in clause 5.1.5, after transmitting HARQ feedback for MAC PDU including UE Contention Resolution Identity MAC CE:
         4> stop timeAlignmentTimer associated with this TAG.

If the SpCell is configured with multiple TAGs and a RA is initiated for a reason (e.g., RACH initiated for SR, BFR or LBT failure etc.) other than a TA of the TAG of the SpCell, during the random-access procedure, for PRACH transmission, for Msg3 transmission and HARQ feedback transmission for Msg4, the UE applies the N_{TA} based on the TA of following TAG of the SpCell:
first TAG
The TAG amongst the two TAGs to be applied in this case is signaled by gNB in RRC message.
Second TAG
TAG indicated in RAR during RA procedure (this is only for Msg4 and HARQ feedback)

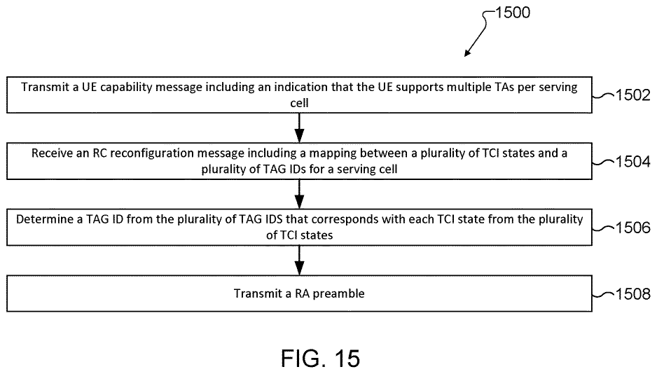

FIG. 15 illustrates a method 1500 for maintaining a plurality of timing advances in a serving cell according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments for maintaining a plurality of timing advances in a serving cell could be used without departing from the scope of this disclosure.

As illustrated in FIG. 15, the method 1500 begins at step 1502. At step 1502, a UE such as UE 116 of FIG. 1 transmits capability information message including an indication that the UE supports multiple TAs per serving cell. At step 1504, the UE receives from a BS, such as gNB 103 of FIG. 1, a RRC reconfiguration message signaling a serving cell is associated with multiple TAGs. The RRC includes a mapping between a plurality of TCI states and a plurality of TAG IDs for the serving cell. At step 1506, the UE determines, based on the mapping, a TAG ID from the plurality of TAG IDs that corresponds with each TCI state from the plurality of TCI states. Finally, at step 1508, the UE transmits a RA preamble.

Although FIG. 15 illustrates one example of a method 1500 for maintaining a plurality of timing advances in a serving cell, various changes may be made to FIG. 15. For example, while shown as a series of steps, various steps in FIG. 15 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE), the method comprising:
receiving, from a base station, configuration information for a serving cell, the configuration information including a first timing advance group (TAG) identity for a first TAG associated with the serving cell and a second TAG identity for a second TAG associated with the serving cell;
receiving, from the base station, a timing advance command and a bit indicating one of two TAGs comprising the first TAG and the second TAG to which the timing advance command is applied; and
applying the timing advance command for the TAG indicated by the bit.

2. The method of claim 1, wherein the timing advance command and the bit are included in a random access response message.

3. The method of claim 1, wherein the timing advance command and the bit are included in an absolute timing advance command medium access control (MAC) control element (CE).

4. The method of claim 1, further comprising starting or restarting a time alignment timer associated with the TAG indicated by the bit.

5. The method of claim 4, further comprising, in response to expiration of a contention resolution timer, stopping the time alignment timer associated with the TAG indicated by the bit.

6. The method of claim 4, wherein:
the serving cell is a special cell (SpCell); and
the method further comprises, in response to expiration of the time alignment timer associated with the TAG indicated by the bit while a time alignment timer associated with another TAG of the two TAGs is not running, at least one of:
flushing all hybrid automatic repeat request (HARQ) buffers for all serving cells;
notifying a radio resource control (RRC) to release a physical uplink control channel (PUCCH) for all serving cells;
notifying the RRC to release sounding reference signal (SRS) for all serving cells;
clearing any configured downlink assignments and configured uplink grants;
clearing any physical uplink shared channel (PUSCH) resource for semi-persistent channel state information (CSI) reporting;
considering all running time alignment timers as expired; or
maintaining an N_{TA} value of all TAGS.

7. The method of claim 1, further comprising receiving, from the base station, information indicating an association between a transmission configuration indication (TCI) state and a TAG of the two TAGs.

8. The method of claim 1, further comprising transmitting, to the base station, capability information on a multi downlink control information (DCI) based multi transmission and reception point (TRP) with two timing advances per serving cell.

9. A method of operating a base station (BS), the method comprising:
transmitting, to a user equipment (UE), configuration information for a serving cell, the configuration information including a first timing advance group (TAG) identity for a first TAG associated with the serving cell and a second TAG identity for a second TAG associated with the serving cell; and
transmitting, to the UE, a timing advance command and a bit indicating one of two TAGs comprising the first TAG and the second TAG to which the timing advance command is applied.

10. The method of claim 9, wherein the timing advance command and the bit are included in a random access response message.

11. The method of claim 9, wherein the timing advance command and the bit are included in an absolute timing advance command medium access control (MAC) control element (CE).

12. The method of claim 9, further comprising transmitting, to the UE, information indicating an association between a transmission configuration indication (TCI) state and a TAG of the two TAGs.

13. The method of claim 9, further comprising receiving, from the UE, capability information on a multi downlink control information (DCI) based multi transmission and reception point (TRP) with two timing advances per serving cell.

14. An electronic device comprising:
at least one processor including processing circuitry; and
memory storing instructions, wherein the instructions, when executed by the at least one processor individually or collectively, cause the electronic device to:
receive, from a base station, configuration information for a serving cell, the configuration information including a first timing advance group (TAG) identity for a first TAG associated with the serving cell and a second TAG identity for a second TAG associated with the serving cell;
receive, from the base station, a timing advance command and a bit indicating one of two TAGs comprising the first TAG and the second TAG to which the timing advance command is applied; and
apply the timing advance command for the TAG indicated by the bit.

15. The electronic device of claim 14, wherein the timing advance command and the bit are included in a random access response message or an absolute timing advance command medium access control (MAC) control element (CE).

16. The electronic device of claim 14, wherein the instructions, when executed by the at least one processor individually or collectively, further cause the electronic device to start or restart a time alignment timer associated with the TAG indicated by the bit.

17. The electronic device of claim 16, wherein the instructions, when executed by the at least one processor individually or collectively, further cause the electronic device to, in response to expiration of a contention resolution timer, stop the time alignment timer associated with the TAG indicated by the bit.

18. The electronic device of claim 16, wherein:
the serving cell is a special cell (SpCell); and
wherein the instructions, when executed by the at least one processor individually or collectively, further cause the electronic device to, in response to expiration of the time alignment timer associated with the TAG indicated by the bit while a time alignment timer associated with another TAG of the two TAGs is not running, at least one of:
flush all hybrid automatic repeat request (HARQ) buffers for all serving cells;
notify a radio resource control (RRC) to release a physical uplink control channel (PUCCH) for all serving cells;
notify the RRC to release sounding reference signal (SRS) for all serving cells;
clear any configured downlink assignments and configured uplink grants;
clear any physical uplink shared channel (PUSCH) resource for semi-persistent channel state information (CSI) reporting;
consider all running time alignment timers as expired; or
maintain an N_{TA} value of all TAGS.

19. The electronic device of claim 14, wherein the instructions, when executed by the at least one processor individually or collectively, further cause the electronic device to receive, from the base station, information indicating an association between a transmission configuration indication (TCI) state and a TAG of the two TAGs.

20. The electronic device of claim 14, wherein the instructions, when executed by the at least one processor individually or collectively, further cause the electronic device to transmit, to the base station, capability information on a multi downlink control information (DCI) based multi transmission and reception point (TRP) with two timing advances per serving cell.
